(19) United States
(12) Patent Application Publication
(10) Pub. No.: US 2019/0098912 A1
(43) Pub. Date: Apr. 4, 2019

(54) BAKE STABLE COMPOSITION

(71) Applicant: CARGILL, INCORPORATED, Wayzata, MN (US)

(72) Inventors: Jeroen DE PAEPE, Sint Maria-Oudenhove (BE); Ellen HUIZENGA, Vilvoorde (BE); Joost TER HAAR, Deventer (NL)

(73) Assignee: CARGILL, INCORPORATED, Wayzata, MN (US)

(21) Appl. No.: 16/086,703

(22) PCT Filed: Mar. 24, 2017
(86) PCT No.: PCT/US2017/023961

§ 371 Date: Sep. 20, 2018

(30) Foreign Application Priority Data
Mar. 24, 2016 (EP) 16162230.3
May 3, 2016 (EP) 16168038.4

(51) Int. Cl. A23D 9/007; A21D 13/38; A21D 13/31

(52) U.S. Cl. CPC A23D 9/007; A21D 13/38; A21D 13/31; A23V 2250/18; A23V 2250/628; A23V 2250/54246; A23V 2002/00

(57) ABSTRACT

The present invention relates to a bake stable composition, in particular a bake stable fat composition comprising from 30-60 wt % of sweetener, from 20-45 wt % of lipid, and from 1 to 20 wt % of caseinate. The bake stable composition is particularly suitable for use in bakery products and comprises 3% moisture or less. The invention further relates to a process for making the bake stable composition of the present invention. Further, the invention relates to the use of caseinate to increase the bake stability of a composition, in particularly of a fat filling composition.

### CROSS-REFERENCE TO RELATED APPLICATIONS

This application claims the benefit of European Patent Application No. 16162230.3, filed Mar. 24, 2016, entitled BAKE STABLE COMPOSITION, and European Patent Application No. 16168038.4, filed May 3, 2016, entitled BAKE STABLE COMPOSITION, which applications are hereby incorporated by reference herein in their entirety.

### FIELD OF THE INVENTION

The present invention relates to a bake stable composition, in particular, the invention relates to a bake stable fat composition. The bake stable composition is particularly suitable for use in bakery products, in particular in baked bakery products. The invention further relates to a process for making the bake stable composition of the present invention. Further, the invention relates to the use of caseinate to increase the bake stability of a composition, in particularly of a fat filling composition.

### BACKGROUND

Use of fillings, toppings, inclusions, and coating compositions in food manufacture is popular due to the variety of foods, tastes and textures that can be created. Different types of fillings, toppings, inclusions and coating compositions are available. However, they typically have a relatively high fat content and, as such, may be referred to as fat-based compositions (e.g. fat-based filling compositions or “fat fillings” for short). These fat-based compositions are often used in or with bakery products. In addition to the fat-based composition, such products typically comprise a dough component (such as a puff pastry dough, a biscuit dough, or any other kind of bakery dough) with the fat-based composition typically having a different texture, colour and/or taste profile than the dough component.

Bake stability of these fat-based compositions, also referred to as heat resistance or heat stability, remains a problem in the food industry. Bake stability is the retention of the composition's shape, colour and texture during baking.

When exposed to high baking temperatures, fat-based compositions with a low bake stability will lose their original shape: they might be deformed, might flow out and so on. Also the original texture is affected, and an initially smooth/creamy and soft composition will turn into a grainy/crumbly and harder composition after baking, which results in a non-appealing final product. What's more, during baking Maillard reactions and caramelization can take place and the colour of the applied products can change. Thus good bake stability is characterized by good shape stability (e.g. characterized by a low flow out), good texture stability (e.g. characterized by a smooth, non-crumbly texture), and good colour stability (e.g. no undesirable browing) after baking of the food product.

Currently, to prevent above mentioned problems, some fat-based compositions are only added to the food product after baking. Thus heating of the fat-based composition itself is prevented. Such products typically have a short shelf life. Other solutions comprise selecting the ingredients of the composition in order to increase the bake stability.

WO2012054452 relates to a grain-based food filling composition that is heat-stable up to an oven temperature of at least about 500° F. (about 260° C.). The use of grain based components is not always desirable.

EP368602A2 discloses the use of a combination of two emulsifying proteins in oil and/or fat in water emulsion, to obtain a filling which is stable to the baking step but which undergoes controlled breakdown upon reheating and provides further desirable mouthfeel characteristics.

JP59045836A relates to the use of a combination of natural viscosity-increasing agent and/or synthetic substance to provide bake stability to fillings.

JP1277450A relates to thermos-resistant filling-topping material of oil-in-water emulsion comprising a mixture of oil and fat, water, solid milk component, egg white and saccharides.

There is however still a need to provide improved bake stable compositions for use in food, in particular to provide an improved bake stable fat-based composition. The present invention provides for such compositions.

### STATEMENTS OF THE INVENTION

The present invention relates to a non-powder composition comprising:

from 30 to 60 wt % of sweetener,

from 20 to 45 wt % of lipid, and

from 1 to 20 wt % of caseinate

characterised in that the composition comprises 3 wt % moisture or less, based on total weight of the composition.

The present invention further relates to a food product comprising the composition of the present invention and further food ingredients.

The present invention further relates to the use of caseinate to increase the bake stability of a composition.

### DETAILED DESCRIPTION

The present invention relates to a bake-stable composition comprising:

From 30 to 60 wt % of sweetener,

From 20 to 45 wt % of lipid, and

From 1 to 20 wt % of caseinate.

The composition may be a filling (or “filling composition”) which is fully or partially encased in a food product; an inclusion which is dispersed throughout a food product e.g. in the form of pearls, nuggets, drops, chips, or other regular or irregular shapes; a topping (or “topping composition”) which is disposed, e.g. as a layer, onto a food product; and/or a coating (or “coating composition”) which covers one or more surfaces of a food product.

The composition of the present invention can be used in bakery products, such as pastries, puffed pastries, cakes, muffins, biscuits and the like. Preferably, the composition will be added to such products prior to baking, i.e. to uncooked or only partially cooked bakery products. They will advantageously be used as a filling composition or for the production of inclusions for use in baked products.

The composition of the present invention may or may not comprise cocoa powder. Preferably, the composition of the present invention will not comprise cocoa powder. In the art, a filling composition not comprising cocoa powder is usually referred to as a “white filling”. Typically, a white filling comprises fat, sugar and milk solids, and optionally additional ingredients such as flavourings.

Advantageously, the composition of the present invention will not be in the form of an emulsion.

Preferably the ingredients of the composition will have a small particle size, preferably 60 μm and below, such as 50 μm and below or 40 μm and below, for example from 1 to 60 μm, or from 1 to 50 μm or from 10 to 40 μm or from 20 to 30 μm. Particle size can be obtained by refining the ingredients using well-known techniques in the art, such as roller refining or dry-grinding. Particle size can be measured with a micrometer, also known as a micrometer screw gauge. When using a micrometer, the particle size value given to the ingredient corresponds to the particle size of the biggest particles.

### Sweetener

The sweetener can be any suitable sweetener for use in a composition as described herein, in particular any suitable sweetener for use in a filling composition or for use in the production of inclusions. The sweetener can be a mixture of several sweeteners. The sweetener may be a nutritive carbohydrate sweetener and/or a sugar substitute.

Suitable nutritive carbohydrate sweeteners may be, but are not limited to, sucrose (for example from cane or beet), dextrose, fructose, lactose, maltose, glucose syrup, fructose syrup, corn syrup, invert sugar, honey, maple sugar, brown sugar, molasses and the like. The nutritive carbohydrate sweetener can be used in crystalline or syrup form.

Suitable sugar substitutes may be, but are not limited to, bulking agents, sugar alcohols, i.e. polyols, or high intensity sweeteners, or combinations thereof.

Suitable high intensity sweeteners include aspartame, acesulfame salts such as acesulfame-K, saccharins, cyclamates, sucralose, alitame, neotam, steviosides, glycyrrhizin, neohesperidin dihydrochalone, monatin, monellin, thaumatin, brazzein, and mixtures of two or more thereof.

The polyols can be selected form tetritols, pentitols, hexitols and higher polyols and the like. The polyols can be but are not limited to sorbitol, mannitol, xylitol, arabinitol, iditol, galactitol, maltitol, isomaltitol, isomalt, erythritol, lactitol, and mixtures of two or more thereof.

Suitable bulking agents may be any of those typically used in the art and include polydextrose, cellulose and its derivatives, maltodextrin and the like, and mixtures thereof.

Preferably, the sweetener comprises sucrose and more preferably the sweetener is sucrose.

The sweetener is present in the composition of the present invention in an amount of from 30 wt % to 60 wt %, more preferably from 40 wt % to 50 wt %, even more preferably from 45 wt % to 50 wt %, based on the weight of the composition. It will be understood that this amount refers to nutritive carbohydrate sweeteners and that, in the event that sugar substitutes are used, the skilled person will be able to determine the appropriate amount to use to achieve an equivalent sweetness.

### Lipid

The lipid present in the composition of the present invention can be a fat and/or an oil. Fats are solid at room temperature (20° C.), oils are liquid at room temperature (20° C.).

The lipid is present in the composition of the present invention in an amount of from 20 wt % to 50 wt %, preferably 25 wt % to 45 wt %, more preferably 28 wt % to 40 wt %, based on the weight of the composition.

The lipid can be any suitable lipid for use in the composition of the present invention as described herein, in particular for use in a filling composition or for use in the production of inclusions. The lipid may be a single fat or it may be a mixture of several lipids. The lipid may be modified, e.g. by hydrogenation, interesterification, and/or fractionation, or it may be in its natural state, although ideally refined. Preferably, the lipid may comprise one or more vegetable lipids such as palm oil, palm kernel oil, shea butter, cocoa butter, coconut oil, rapeseed oil, soybean oil, corn oil, or sunflower oil. Alternatively, it may include or consist of a cocoa butter alternative (including cocoa butter substitutes, replacers and/or equivalents). The lipid may also comprise milk fat, preferably amorphous milk fat.

The specific lipid to be used will be determined by a person skilled in the art based on the desired end application. For example, for a filling composition, the lipid will preferably comprise rapeseed oil, palm oil and/or palm kernel oil. Although not wishing to be bound by theory, it is believed that the addition of palm kernel oil and/or palm oil is advantageous to provide structure to the composition in order to keep it pumpable and processable at room temperature. For inclusions, the lipid will preferably comprise or consist of fats that are solid at room temperature such as shea butter, coconut oil, cocoa butter and/or cocoa butter alternatives. For the production of white chocolate or white compound compositions, the lipid will preferably include amorphous milk fat together with one or more vegetable lipids.

Preferably, the bake-stable compositions of the present invention, especially in the form of a filling composition, will comprise from 2 to 15 wt %, more preferably from 4 to 8 wt %, such as about 5 wt % of palm oil and/or palm kernel oil, based on the weight of the composition, the remaining of the lipid being preferably vegetable oil such as sunflower oil or rapeseed oil. Further, it may be advantageous that the composition comprises from 1 to 2 wt % of anhydrous milk fat, based on the weight of the composition, to improve the taste profile of the composition.

### Caseinate

The composition of the present invention comprises from 1 to 20 wt %, preferably from 5 to 15 wt %, more preferably from 10 to 15 wt % of caseinate based on the weight of the composition. Caseinate and process for producing it are known in the art. Typically, caseinate is produced from defatted milk. The milk is heated to around 45° C. and casein is separated by the addition of acid. The casein is then washed, an alkali added and the mixture heated to around 85° C., after which the slurry is dried. The resulting material is soluble caseinate. For the purpose of the present invention, the term “caseinate” may refer to sodium-caseinate (Na-caseinate) and/or potassium-caseinate (K-caseinate) and/or calcium-caseinate (Ca-caseinate).

### Other Ingredients

The composition of the invention may comprise some water. However, this will principally come from the moisture present in other ingredients of the composition and will account for no more than 3 wt % of the total composition. Thus, the composition may comprise from 0.5 to 3 wt % of water. More preferably, the water content of the composition will be 1.5 to 2 wt % based on the total weight of the composition. Ideally, the composition of the invention will include no free water, i.e. no water added as such to the composition.

The composition may comprise an emulsifier. The amount of emulsifier can be from 0.1 to 2 wt % based on the weight of the composition. The emulsifier may be selected from the group consisting of lecithin, ammonium phosphatide, propane-1,2-diol esters of fatty acids, sucrose esters of fatty acids, sucroglycerides, polyglycerol esters of fatty acids, polyglycerol polyricinoleate sorbitan esters, sorbitan tristearate, stearoyl-2-lactylates, and mixtures of two or more thereof.

In addition to caseinate, the composition may also comprise other milk ingredients such as milk solids. Milk solids may be included in the composition of the invention in an amount of from 1 to 10 wt %, preferably 5 to 10 wt % based on the weight of the composition. Milk solids may include, for instance, skimmed milk powder, which comprises less than 2 wt % of milk fat; whole milk powder, which comprises around 2 to 4 wt % of milk fat; and mixtures thereof.

The composition may further comprise one or more other ingredients depending on the final use of the composition. Such further ingredients may include colouring agents, flavouring agents, chocolate solids (such as cocoa powder or cocoa liquor) and the like.

It has been found by the present inventors that the fat-based composition of the present invention has an improved bake stability in comparison to fat-based compositions of the prior art. In particular white fat filling compositions according to the present invention have an improved bake stability in comparison to white fat filling compositions of the prior art. As mentioned above, improved bake stability means both maintenance of the texture, preferably a smooth texture, during and after baking, maintenance of the shape during baking, which results in a lower flow out during baking compared to caseinate-free reference compositions, and colour maintenance, for example less browning or darkening during baking.

The composition of the present invention maintains its shape well during baking. Shape maintenance is evaluated by measuring flow out (as described in Method 1 below). Flow out is measured after baking the composition. The lower the flow out value, the better the composition maintains its shape during baking. The composition of the present invention preferably has a flow out of from 0 to 25%, preferably from 0.1 to 20%, more preferably from 0.5 to 15%, even more preferably from 1.0 to 10% yet even more preferably from 1.5 to 5%.

The composition of the present invention is also characterized in that it advantageously has a smooth texture after baking and preferably no or only minor colour changes. Smooth texture is determined by evaluating the graininess, melting behaviour in the mouth and stickiness behaviour in the mouth according to Method 2 below. The colour can be evaluated visually. Advantageously, the composition of the present invention has better colour stability (i.e. less colour change/less browning) after baking than equivalent compositions without caseinate.

Depending on the end use of the composition, it may either be provided in solid, semi-solid or liquid form. Inclusions, for example, will typically be provided in solid form for mixing e.g. with the other ingredients of a bakery product. Coatings, by contrast, will typically be provided in liquid form so that they are able to coat the bakery product (e.g. through pouring or dipping). The viscosity of the composition will define the thickness of the final coating. The composition of the present invention will preferably have a viscosity of from 500 to 10000 mPa·s, preferably from 1500 to 7000 mPa·s, even more preferably from 3000 to 5000 mPa·s. Viscosity is measured according to Method 3, below.

The composition of the invention will preferably be provided in a ready-to-use form. In other words, it will preferably be in a form that can be applied directly to or directly incorporated into a bakery product, that is without the addition of further ingredients or the need for specific processing or preparation steps. This distinguishes the compositions of the present invention from compositions which require the addition, for example, of water or milk before use, to form a mousse, whip, cream or jelly. Thus, the composition of the invention is preferably a non-powder composition, that is the composition is not a powder or other form of pre-mix. The term “powder” should be understood to mean any loose or flowable powder or granular compositions.

The composition of the present invention may be produced by mixing the separate ingredients (sweetener, lipid, caseinate and any other ingredients) together, preferably until a homogenous composition is obtained. The ingredients may be added sequentially, in any order, or simultaneously. Standard methods of producing fillings, coatings, inclusions and toppings will be well known in the art and a skilled person will readily be able to adapt them to produce compositions of the present invention. Thus, the present invention provides a process for producing bake stable compositions, particularly bake stable fat-based compositions.

The present invention further provides food products comprising the composition of the present invention together with one or more additional food ingredients. Such food products, whether in an uncooked, cooked, or partially cooked form, may include baked food products, as such pastries, puffed pastries, cakes, muffins, biscuits and the like. A typical method of producing such food products may include the following steps: (i) providing a dough or dough mix; and (ii) adding the composition of the present invention. In the event a dry dough mix is used in step (i), the method may also include a step of finishing the dough by addition of a liquid such as water, milk and/or egg. The method may also include one or more shaping steps in which the dough is shaped, prior to and/or after addition of the composition of the invention. The prepared product may then be stored (preferably refrigerated or frozen) or cooked.

Finally, the invention relates to the use of caseinate in a filling, coating, topping and inclusion-type compositions, to increase their bake stability, in particular to increase their shape, texture and colour stability during and after baking, compared to equivalent caseinate-free compositions.

### Methods of Measurement

### Method 1—Shape Retention:

The flow out of the composition is evaluated as follows.

The composition is prepared by mixing its ingredients together until a homogenous composition is obtained. 9 bars, each 11.5 cm long and each weighing from 38.4±2 grams, are prepared by putting the filling composition in moulds of about 11.5 cm long. All 9 bars have an equal weight±max 2 g. The mould containing the filling composition is put in a freezer for 2 days. After 2 days, the 9 filling compositions are demoulded, and puff pastry products are prepared. The puff pastry dough is a pre-made puff pastry form Vandemoortele (“Plak gerezen bladerdeeg 4 mm” sold under the brand name Banquet D′ Or, with product number 26965). One filling composition is placed on a rectangular puff pastry dough of 11.5 cm long such that the filling composition does not exceed the puff pastry dough in length and such that the filling is placed in the middle of the rectangular puff pastry dough in breadth. The dough is folded in the breadth in order to cover the filling composition. Nine pastries are each prepared as above. The pastries are put on a baking plate and in the rising chamber at 35° C. for 1 h. The pastries are then baked at 190° C. for 15 minutes.

After cooling down at room temperature (20° C.) for 12 hours, the weight of the filling that is visible and has flown out of the nine pastries is cut off, weighed (W) and the average weight is calculated (W/9). This average weight is recalculated to the % of flow out by dividing the average flow out weight by the average weight of 1 bar and multiplying the outcome by 100.

### Method 2—Texture/Colour:

Filling texture is evaluated by tasting the baked composition after baking.
1) The surface layer of the baked filling inside the baked puff pastry is evaluated on graininess (crumbliness).
2) The center of the filling is evaluated on graininess and also on melting behavior/stickiness (taste viscosity).
3) The colour is evaluated visually.
   All these parameters are evaluated by a taste panel of 3 trained panelists.

The texture of a baked inclusion is evaluated by a taste panel of 3 trained panelists for taste profile, melting performance and graininess. Its colour (colour change/darkness) is evaluated visually.

### Method 3—Viscosity

Viscosity is measured at 40° C.

The viscosity of the filling composition before baking is measured with an Anton Paar MCR51 rheometer coupled with a cylinder measuring system CC27 following the ISO 3219 method.

The invention will now be illustrated in the following examples.

### EXAMPLES

### Example 1

Filling compositions are prepared based on the ingredients listed in table 1.

All dry powders (sugar, caseinate) are mixed. The particle size of the powder mix is reduced to 25±2 μm in a dry grind mill from Bauermeister.

8 kg of final product is prepared by adding the milled dry ingredients to a conche (Buhler pilot conche, Elkolino) and adding 30% of the total fat phase. This is mixed for 20 minutes at a speed of 10 Hz. After 20 minutes, the mixing is stopped and the remaining product is scraped from the edges followed by mixing at 10 Hz for 5 minutes. Finally, the rest of the fat and the lecithin are added and mixed for 10 minutes at 10 Hz.

The viscosity and particle size is measured. Viscosity and particle size values are as shown in Table 1.

The compositions obtained are used as a filling composition in the production of filled puffed pastries. 9 bars of each composition, each 11.5 cm long and each weighing 38.4±2 grams (for the composition of the invention) and 41±2 g (for the reference composition), are prepared by putting the filling composition in moulds of about 11.5 cm long. All 9 bars have an equal weight±max 2 g. The mould containing the filling composition is put in a freezer for 2 days. After 2 days, each set of 9 filling compositions are demoulded, and puff pastry products are prepared. The puff pastry dough is a pre-made puff pastry form Vandemoortele (“Plak gerezen bladerdeeg 4 mm” sold under the brand name Banquet D′Or, with product number 26965). One moulded filling is placed on a rectangular puff pastry dough of 11.5 cm long such that the filling composition does not exceed the puff pastry dough in length and such that the filling is placed in the middle of the rectangular puff pastry dough in breadth. The dough is folded in the breadth in order to cover the filling composition. Nine reference pastries and 9 pastries according to the invention are prepared as above. The pastries are put on a baking plate and in the rising chamber at 35° C. for 1 h. The pastries are then baked at 190° C. for 15 minutes.

After cooling down at 20° C. for 12 hours, the flow out is measured and the compositions are tasted by a panel of 3 trained panellists to evaluate the taste and texture. Flow out values and texture values are as shown in table 1.

TABLE 1

| | Reference | Filling |
|---|---|---|
| | filling | composition according |
| | composition | to the invention |
| White table sugar (wt %) | 69 | 49 |
| Na-caseinate (wt %) | 0 | 20 |
| Total powder phase (wt %) | 69 | 69 |
| Palm kernel oil (wt %) | 5 | 5 |
| Anhydrous milk fat (wt %) | 1 | 1 |
| Rapeseed oil (wt %) | 25 | 25 |
| Total fat phase (wt %) | 31 | 31 |
| Soy lecithin (wt %) | 0.2 | 0.28 |
| Viscosity (mPa · s) | 1057 | 5459 |
| Average particle size (μm) | 24 | 24 |
| Flow out (g) | 8.9 | 4.4 |
| Average weight of 1 bar | 41.0 grams | 38.4 grams |
| Flow out (%) | 21.7 | 11.5 |
| Texture: taste viscosity | Dry/hard | Very liquid/very creamy |
| Texture: crumbliness | Crumbly/grainy | Not crumbly/very good |
| | | texture |

### Example 2

Compositions for use as inclusions are prepared according to the method described in Example 1, with the ingredients listed in Table 3. After preparation of the liquid product, circle shaped inclusions are prepared having a diameter of approximately 1 cm. Cookie dough is prepared by mixing the ingredients listed in Table 2.

TABLE 2
cookie dough recipe

| Ingredients | grams | % |
|---|---|---|
| Kolibri flour | 796.5 | 40.37 |
| Palm fat | 308.28 | 15.63 |
| Lecithin | 11.4 | 0.58 |
| Icing Sugar | 291.84 | 14.79 |
| Salt | 11.46 | 0.58 |
| Sodium bicarbonate | 11.46 | 0.58 |
| Skimmed Milk powder | 12.9 | 0.65 |
| Cocoa powder | 48.6 | 2.46 |
| Water | 144.3 | 7.31 |
| Glucose syrup | 40.5 | 2.05 |
| Ammonium Bicarbonate | 5.73 | 0.29 |
| White bake stable inclusions | 290 | 14.7 |
| Total: | 1972.97 | 100 |

2 kg of dough and inclusions are prepared in a Hobart N50+paddle. First, the fat, sugar, skimmed milk powder, salt, ammonium bicarbonate and sodium bicarbonate are mixed for 1 min at speed 1. Water, lecithin, and syrup are then added and mixing is resumed for 1 min at speed 1. Mixing speed is then increase to speed 2 and mixing is continued for a further 3 minutes. The flour is added and mixing is resumed for 1 min at speed 1. Finally, the inclusions (either reference or of the invention) are added to the dough and mixed using the Hobart at speed 1 until the inclusions are spread homogenously throughout the dough. The dough is then rested for 20 min at 6° C.

After resting, the dough is rolled to a thickness of about 1 cm and circular cookies of 15-17 g and 5.5-6 cm in diameter each are prepared by wire cutting.

The cookies are then baked at 175/205° C. for approximately 20 minutes in a conventional oven.

After baking, the cookies are allowed to cool at room temperature and, after 1 day, the inclusions are evaluated on texture and colour.

Table 3 shows the recipes of the inclusions (the reference and the invention) together with the evaluation summary of the texture and colour of the inclusions evaluated in the biscuits.

TABLE 3

| | Reference | Inclusion |
|---|---|---|
| | inclusion | composition according |
| | composition | to the invention |
| White table sugar (wt %) | 50.03 | 58.85 |
| Skimmed milk powder (wt %) | 5 | — |
| Denim whey powder (wt %) | 10 | — |
| Na-caseinate (wt %) | — | 10 |
| Palm kernel oil (wt %) | 30.5 | 27 |
| Palm oil (wt %) | 3.5 | 3 |
| Anhydrous milk fat (wt %) | — | 1 |
| Sorbitan tri-stearate | 0.7 | — |
| Flavourings | 0.1 | 0.1 |
| Soy lecithin | 0.17 | 0 |
| texture | grainy | Less grainy |
| colour | Brown | Less brown, more white |

1. A non-powder composition comprising:
a. from 30 to 60 wt % of sweetener,
b. from 20 to 45 wt % of lipid, and
c. from 1 to 20 wt % of caseinate;
characterised in that the composition comprises 3% moisture or less.

2. The composition of claim 1 wherein the sweetener is sucrose.

3. The composition of claim 1 wherein the composition does not comprise cocoa powder.

4. The composition of claim 1 wherein the caseinate is selected from the group consisting of sodium-caseinate, calcium-caseinate, potassium-caseinate, and mixtures of two or more thereof.

5. The composition of claim 1 wherein the composition is selected from a filling composition, a coating composition, a topping composition, or an inclusion composition.

6. The composition of claim 1 wherein the composition is a filling composition and has a flow out of 25% or less, measured according to Method 1.

7. The composition of any claim 1, characterised in that it has better bake stability relative to an equivalent composition prepared without caseinate.

8. The composition of claim 7, characterised in that it has better shape retention, better texture retention, and/or better colour retention relative to an equivalent composition prepared without caseinate.

9. A food product comprising the composition of claim 1 together with one or more additional food ingredients.

10. The food product of claim 9 wherein the food product is a bakery product.

11. Use of caseinate to improve the bake stability of a composition.

12. The use according to claim 11 wherein the composition comprises:
a. from 30 to 60 wt % of sweetener
b. from 20 to 45 wt % of fat
c. from 1 to 20 wt % of caseinate.
